(19) United States
(12) Patent Application Publication
(10) Pub. No.: US 2021/0285219 A1
(43) Pub. Date: Sep. 16, 2021

(54) COMPOSITE ROOFING MEMBRANE

(71) Applicant: Milliken & Company, Spartanburg, SC (US)

(72) Inventors: David E. Wenstrup, Greer, SC (US); Garrett H. Parcells, Simpsonville, SC (US)

(21) Appl. No.: 17/138,157

(22) Filed: Dec. 30, 2020

Related U.S. Application Data
(60) Provisional application No. 62/988,688, filed on Mar. 12, 2020.

(51) Int. Cl. E04D 5/10; E04D 5/06; E04D 5/08

(52) U.S. Cl. CPC E04D 5/10; E04D 5/06; B32B 5/022; B32B 2262/04; E04D 5/08

(57) ABSTRACT

A composite roofing membrane is disclosed having upper and lower surfaces. The composite roofing membrane contains, in order, a first membrane, a second membrane, and a nonwoven fleece. The first membrane has a first side and a second side, where the first side of the first membrane forms the upper surface of the composite roofing membrane, and where the first membrane comprises a thermoplastic polymer. The second membrane has a first side and a second side, where the first side of the second membrane is adjacent to and in direct and intimate contact with the second side of the first membrane, and where the second membrane comprises a thermoplastic polymer. There are no fibers or yarns between the first and second membranes. The nonwoven fleece contains a plurality of yarns, has a tensile strength of between 100 and 1000 lb_{f}, and a tear strength of between 20 and 200 lb_{f}.

### RELATED APPLICATIONS

This application claims priority to co-pending U.S. Provisional Patent Application 62/988,688 filed on Mar. 12, 2020, which is herein incorporated by reference in its entirety.

### TECHNICAL FIELD

The present invention relates generally to roofing membranes, more particularly to roofing membranes containing fleece.

### BACKGROUND

Materials and construction methods for production of singly ply membrane roofing materials are varied but generally consist of a top ply and bottom ply thermoplastic membrane surrounding a structural scrim. Often used in “glue down” applications a needlefelt or fleece nonwoven is added to the backside of the bottom membrane to enhance the ability of the membrane composite to stick to the roof deck of the structure and provide a barrier between the glue and membrane. There is a need to have single ply roofing membrane that has good strength and other attributes.

### BRIEF SUMMARY OF THE INVENTION

A composite roofing membrane is disclosed having upper and lower surfaces. The composite roofing membrane contains, in order, a first membrane, a second membrane, and a nonwoven fleece. The first membrane has a first side and a second side, where the first side of the first membrane forms the upper surface of the composite roofing membrane, and where the first membrane comprises a thermoplastic polymer. The second membrane has a first side and a second side, where the first side of the second membrane is adjacent to and in direct and intimate contact with the second side of the first membrane, and where the second membrane comprises a thermoplastic polymer. There are no fibers or yarns between the first and second membranes. The nonwoven fleece contains a plurality of yarns, has a tensile strength of between 100 and 1000 lb_{f}, and a tear strength of between 20 and 200 lb_{f}.

A composite roofing membrane is disclosed having an upper surface and a lower surface. The composite roofing membrane contains, in order a first membrane and a nonwoven fleece. The first membrane has a first side and a second side, where the first side of the first membrane forms the upper surface of the composite roofing membrane, and where the first membrane comprises a thermoplastic polymer. The nonwoven fleece has a first side and a second side, where the first side of the nonwoven fleece and the second side of the first membrane are adjacent, where the nonwoven fleece contains a plurality of yarns, and where the nonwoven fleece has a tensile strength of between 100 and 1000 lb_{f} and a tear strength of between 20 and 200 lb_{f}.

A composite roofing membrane is disclosed having upper and lower surfaces. The composite roofing membrane contains, in order, a first membrane, a second membrane, and a fire resistant (FR) fleece. The first membrane has a first side and a second side, where the first side of the first membrane forms the upper surface of the composite roofing membrane, and where the first membrane comprises a thermoplastic polymer. The second membrane has a first side and a second side, where the first side of the second membrane is adjacent to and in direct and intimate contact with the second side of the first membrane, where the second membrane comprises a thermoplastic polymer, and where there are no fibers or yarns between the first membrane and the second membrane. The FR fleece has a first side and a second side, where the first side of the FR fleece and the second side of the second membrane are in intimate contact, where the second side of the FR fleece forms the lower surface of the composite roofing membrane, where the FR fleece comprises a plurality of FR rayon staple fibers and a plurality of char scaffold fibers selected from the group consisting of partially oxidized acrylonitrile and silica staple fibers, where the FR fleece further comprises a first scrim embedded into the fleece, where the first scrim has a machine and cross-machine direction and comprises a plurality of glass fibers, where the first scrim has a construction selected from the group consisting of a knit, woven, or non-woven, and where the tensile strength of the first scrim in the machine direction is at least about 100 N/cm².

A composite roofing membrane is disclosed having upper and lower surfaces. The composite roofing membrane contains, in order, a first membrane, a second membrane, and a FR fleece. The first membrane has a first side and a second side, where the first side of the first membrane forms the upper surface of the composite roofing membrane, and where the first membrane comprises a thermoplastic polymer. The FR fleece has a first side and a second side, where the first side of the FR fleece and the second side of the first membrane are in intimate contact, where the second side of the FR fleece forms the lower surface of the composite roofing membrane, where the FR fleece comprises a plurality of FR rayon staple fibers and a plurality of char scaffold fibers selected from the group consisting of partially oxidized acrylonitrile and silica staple fibers, where the FR fleece further comprises a second scrim embedded into the fleece, where the second scrim has a machine and cross-machine direction and comprises a plurality of glass fibers, where the second scrim has a construction selected from the group consisting of a knit, woven, or non-woven, and where the tensile strength of the second scrim in the machine direction is at least about 100 N/cm².

A composite roofing membrane is disclosed having upper and lower surfaces. The composite roofing membrane contains, in order, a first membrane, a second membrane, and a nonwoven fleece. The first membrane has a first side and a second side, where the first side of the first membrane forms the upper surface of the composite roofing membrane, and where the first membrane comprises a thermoplastic polymer. The second membrane has a first side and a second side, where the first side of the second membrane is adjacent to and in direct and intimate contact with the second side of the first membrane, where the second membrane comprises a thermoplastic polymer, and where there are no fibers or yarns between the first membrane and the second membrane. The nonwoven fleece has a first side and a second side, where the first side of the nonwoven fleece and the second side of the second membrane are in intimate contact, where the second side of the nonwoven fleece forms the lower surface of the composite roofing membrane, where the nonwoven fleece further comprises a first scrim embedded into the fleece, where the first scrim has a machine and cross-machine direction and comprises a plurality of glass fibers, where the first scrim has a construction selected from the group consisting of a knit, woven, or non-woven, and where the tensile strength of the first scrim in the machine direction is at least about 100 N/cm².

A composite roofing membrane is disclosed having an upper surface and a lower surface. The composite roofing membrane contains, in order a first membrane and a nonwoven fleece. The first membrane has a first side and a second side, where the first side of the first membrane forms the upper surface of the composite roofing membrane, and where the first membrane comprises a thermoplastic polymer.

The nonwoven fleece has a first side and a second side, where the first side of the nonwoven fleece and the second side of the first membrane are in intimate contact, where the second side of the nonwoven fleece forms the lower surface of the composite roofing membrane, where the nonwoven fleece further comprises a first scrim embedded into the fleece, where the first scrim has a machine and cross-machine direction and comprises a plurality of glass fibers, and where the tensile strength of the first scrim in the machine direction is at least about 100 N/cm².

### BRIEF DESCRIPTION OF THE DRAWINGS

The present invention is best understood with reference to the following detailed description of embodiments of the invention when read in conjunction with the attached drawings, in which like numerals refer to like elements, and in which:

FIGS. 1 and 2 are cross-sectional illustrations showing embodiments of the composite roofing membrane.

### DETAILED DESCRIPTION

The present invention generally relates to a composite roofing membrane whereby uniquely blended fleeces and optional scrims are used in tandem to generate a high preforming composite roofing membrane for roofing applications. In some embodiments, this composite roofing membrane, when applied to the roof deck of an architectural structure, is designed to form a ‘char barrier’ with some structural support. This resultant reinforced char is designed to withstand flame spread to the roof deck once the thermoplastic membrane has melted and/or burned away. In some embodiments, the composite roofing membrane is designed to meet or exceed several FR testing protocols common in the roofing industry.

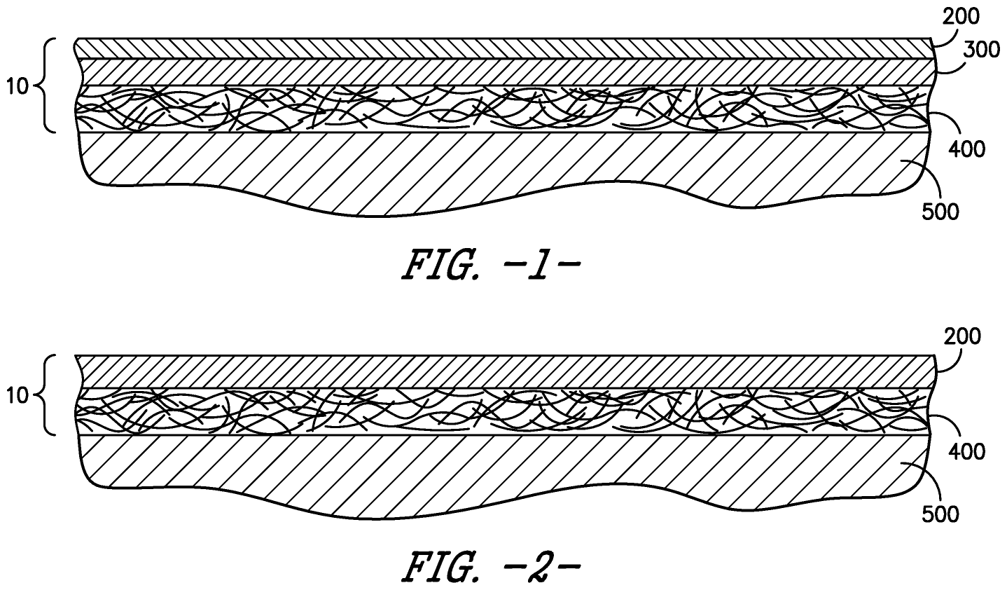

Referring now to FIG. 1, there is shown a cross-sectional illustration of one embodiment of the composite roofing membrane 10. The composite roofing membrane 10 contains a first membrane 200 and a second membrane 300. This dual layer structure 200, 300 can be used as a single ply roofing membrane in mechanically adhered roofing systems and will referred to herein as a “single ply roofing membrane”. In another embodiments, such as shown in FIG. 2, the composite roofing membrane contains only a first membrane 200. This embodiment is also referred to as a single ply roofing membrane.

This single ply roofing membrane is attached to a fleece 400 such that the second membrane 300 and the fleece 400 are adjacent. The composite roofing membrane 10 is attached to a roof 500 (or other structure) oriented such that the fleece 400 is adjacent the roof 500. Preferably, the single ply roofing membrane forms the outer surface of the composite roofing membrane 10. The thickness of the composite roofing membrane (including layers 200, 300, 400) is between about 20 and 200 mils. Preferably, the areal weight of the composite roofing membrane 10 is between about 10 and 100 ounces per square yard.

The first membrane 200 has a first side and a second side and the first side of the first membrane preferably forms the upper surface of the composite roofing membrane 10. The second membrane 300 has a first side and a second side and the first side of the second membrane 300 and the second side of the first membrane 200 are in direct and intimate contact. Preferably, there are no fibers, yarns, or scrims between the first and second membranes 200, 300. In one embodiment, there is an adhesive polymer between the first and second membranes, but in another embodiment, there are no additional materials located between the two membranes.

The first and second membranes 200, 300 comprise a thermoplastic polymer which may be any suitable thermoplastic. Some common thermoplastics include ethylene propylene diene monomer M-class (EPDM) rubber, thermoplastic olefin (TPO), and polyvinyl chloride (PVC). Preferably, the first and second membranes 200, 300 are made from the same thermoplastic polymer. In one embodiment, the first and second membranes 200, 300 comprise polyvinyl chloride. In another embodiment, the first and second membranes 200, 300 comprise thermoplastic olefin. In another embodiment, the first and second membranes 200, 300 comprise EPDM rubber. Preferably, the single ply roofing membrane is at least about 95% wt the first and second membrane, more preferably at least about 99% wt, more preferably at least about 99.9% wt.

In virtually all known applications the top and bottom ply membranes are chosen from the same polymer to enhance adhesion between the two membranes. Differing amounts of additives are common differences between the top ply and bottom ply membrane. Often different colorants are used in the two plys. The top ply membrane will commonly be loaded with UV protective chemistries. The two layers may also require differing amounts of plasticizers or other features to enhance composite membrane performance.

The single ply roofing membrane can be made either through extruding the first and second membrane 200, 300, or by laminating two pre-extruded membranes 200, 300 together. Numerous variations where by extrusion and lamination can be combined in different methods are also commonly used.

The first membrane 200 preferably has a thickness (defined as the distance between the first and second side of the first membrane) of between about 5 and 30 mils. The second membrane 300 preferably has a thickness (defined as the distance between the first and second side of the second membrane) of between about 10 and 60 mils.

Adhesion between the two membranes is very important to insure proper performance in roofing applications, for example wind uplift is tested for all roofing membranes and ply to ply adhesion must be strong enough to withstand pressures of at least about 60 psi, more preferably at least about 120 psi.

Traditional application of the composite membrane structure to architectural roof decking is done with decking screws and washers, followed by overlapping of the next membrane layer to cover the screw and washer hardware from the weather. Recent advances in adhering roofing membranes to architectural roof decks has focused on using adhesives to fully adhere the entire membrane to the deck. In one embodiment, Single ply roofing membranes that are fully ‘glued’ down to the roof deck. This can often display significantly improved wind uplift results by eliminating pockets of non-adhered membrane from uplifting and causing stress on the mechanically adhered sections.

The bottom ply (second) membrane (or the first membrane in embodiments where there is only one membrane) which preferably comprises thermoplastic polymers, tend to not lend themselves to good adhesion using commonly available adhesives especially solvent based adhesives. Often solvent based adhesives will dissolve the thermoplastic in question causing weak spots in the overall composite. Additionally, some water based adhesives can cause degradation and discoloration. Having a layer of fleece between the single ply roofing membrane and the roof deck 500 can both protect the second (or first) membrane and enhance membrane to roof/deck adhesion.

Referring back to FIG. 1, a layer of nonwoven fleece 400 is included in the composite roofing membrane facing the roof 500 to both protect the second membrane 300 and to enhance membrane to roof/deck adhesion. The first side of the fleece 400 and the second side of the first/second membrane 200, 300 are in intimate contact (or are adjacent) and the second side of the fleece 400 forms the lower surface of the composite roofing membrane 10. The second side of the fleece 400 faces the roof deck 500. In one embodiment, the second membrane 300 (or first membrane 200) and the fleece 400 are attached together by an adhesive. They may also be attached together without needing an additional adhesive or may be attached using other attachment methods. Preferably, the fleece 400 is adhered to the second membrane 300 soon after extrusion of the second membrane 300 using heat and pressure.

Common in the industry are polyester (PET) and polypropylene (PP) felts in the basis weight range of 3-10 ounces per square yard (osy). These felts are typically needled to a thickness of between 20 and 200 mils to provide both an adhesion component and protective component to the single ply roofing membrane. Preferably the thickness of the fleece is between about 40 and 120 mils. High fleece density can improve protection of the bottom ply membrane against a corrosive adhesive; however, loft of the fleece can also enhance performance during impact events such as hail.

In one embodiment, the fleece 400 is constructed as a fire resistant (FR) fleece to give the protections to the single ply roofing membrane and to impart FR characteristics to the composite membrane 10. Specifically, the FR fleece is designed to create a structurally stable char barrier which once formed will protect the architectural deck from a fire event.

The FR fleece preferably contains a plurality of non-FR fibers, a plurality of FR fibers, and a plurality of char scaffold fibers. In one embodiment, the FR fleece 400 comprises between about between about 30 and 70% by weight FR rayon staple fibers, between about 20 and 50% by weight FR stable scaffold fibers, and between about 20 and 50% by weight non-FR (typically polyester with no FR additives) fibers.

The non-FR fibers may be any suitable fiber and are included for loft and bulking of the fleece. Non-FR fibers tend to be less expensive than FR fibers so it is advantageous from a cost standpoint to be able to include a percentage of non-FR fibers in the FR fleece 400. These non-FR fibers provide volume in the z direction of the nonwoven material. Types of bulking fibers would include fibers with high denier per filament (5 denier per filament or larger), high crimp fibers, hollow-fill fibers, and the like. These fibers provide mass and volume to the material. Examples of fibers used as bulking fibers include polyester, and polypropylene, as well as other low cost fibers. In one embodiment, the non-FR fibers are thermoplastic fibers, preferably polyester fibers. Preferably, the polyester fibers are crimped to maximize the amount of loft from the fibers. In one embodiment, the percentage by weight of non-FR fibers in the FR fleece is between about 20 and 80%, more preferably between about 25 and 65, more preferably between about 25 and 45%.

The FR fleece also contains an FR fiber, which is defined to be fibers having a Limiting Oxygen Index (LOI) value of 20.95 or greater, as determined by ISO 4589-1. The FR fiber may be, for example, FR chemically treated fibers and inherently FR fibers. Preferably, the FR fibers are FR rayon staple fibers. In one embodiment, the percentage by weight of FR fibers in the FR fleece is between about 20 and 80%, more preferably between about 25 and 65, more preferably between about 25 and 45%.

The FR fleece also preferably includes a plurality of char scaffold fibers. Char scaffold fibers are defined to be fibers that once burned, retain a portion (at least about 80%) of their original strength. These fibers give strength to the fleece after it is burned. The char scaffold fibers may be mineral fibers such as silica and basalt, aramids, carbon fibers including partially oxidized polyacrylonitrile (PAN) and fully carbonized carbon, rayon both inherently FR including with modified cores and chemically treated FR rayon, natural fibers such as wool, and chemically treated synthetic fibers. Preferably, the char scaffold fibers are partially oxidized acrylonitrile (also sometimes referred to as PANOX) staple fibers or silica staple fibers. In one embodiment, the char scaffold fibers are partially oxidized acrylonitrile staple fibers. In another embodiment, the char scaffold fibers are silica staple fibers. Preferably, the FR fibers and char scaffold fibers are different fibers (made from different materials). In one embodiment, the percentage by weight of non-FR fibers in the FR fleece is between about 20 and 80%, more preferably between about 25 and 65, more preferably between about 25 and 45%.

In a further preferred embodiment, a 50/50 mixture by weight of partially oxidized acrylonitrile fabrics and mineral fibers provided a surprising FR improvement in performance due to increased char strength.

Often the char scaffold fibers employed are more brittle and contain significantly less crimp than more traditional fibers used in these applications. For these reasons, numerous enhancements are encouraged including elliptical needling, and proper blending of the fibers in terms of both type and denier to allow proper web formation and carriage through the carding process. Additionally, appropriate web weight and number of crosslaps becomes extremely important when dispersing fibers such as silica and basalt to impart a scaffolding to the char barrier formation.

The fibers in the FR fleece are typically blended to create a uniform fiber blend but when certain performance characteristics are desired can be stratified and or layered. Additionally, the FR fleece may have additional treatments added to it after batt formation including intumescent chemistries and the like.

In one embodiment, the nonwoven fleece has a tensile strength of between 100 and 1000 lb_{f} and a tear strength of between 20 and 200 lb_{f}. This strong fleece may be regular or FR. In another embodiment the nonwoven fleece 400 contains the first scrim embedded into the fleece and the nonwoven fleece (including the scrim) has a tensile strength of between 100 and 1000 lb_{f} and a tear strength of between 20 and 200 lb_{f}. Tensile strength is measured according to ASTM D4632 and tear strength is measured according to ASTM D4533.

In one embodiment, the fleece (which in one embodiment is an FR fleece) may have a first scrim located within the fleece. Preferably, the first scrim can be made from the same materials (preferably glass fibers), same constructions, and same methods as those described in relation to the first scrim. This first scrim provides additional integrity to the fleece both before and after a fire event. The first scrim is preferably incorporated into the fleece, preferably needle-punched with the nonwoven fibers to create the nonwoven fleece. It has been found that the addition of the scrim within the fleece increased the strength of the fleece as compared to having the scrim on one side of the fleece not incorporated with the fleece (simply adhered to the surface). Preferably, the scrim within the nonwoven fleece comprises a plurality of yarns. These yarns are preferably formed from a plurality of fibers which have an average staple length of at least about 12 inches. More preferably, the fibers have an average staple length of at least about 20 inches, more preferably at least about 10 feet, more preferably at least about 100 feet. In another embodiment, the fleece may contain a plurality of yarns as described above not in a scrim structure. In one embodiment, at least about 75% by weight of the fibers in the scrim are considered continuous.

The first scrim 100 has a first side and a second side. The first scrim can be any suitable fabric including knit, woven, or non-woven and has a machine and cross-machine direction. The first scrim preferably has a thickness of between about 5 and 15 mils.

In one embodiment, the first scrim is a laid scrim where yarns (or fibers) are laid in the machine and cross machine direction and are attached together at their cross-over points. Typically, the scrim is designed in an open construction such that fibers from the nonwoven pass around and through the scrim. Preferably, tensile strength of the first scrim 100 in the machine direction is at least about 100 N/cm². This allows installation of the roofing membrane from large rolls without significant distortion. Additionally, it improves the wind uplift performance of the roofing system.

The yarns/fibers making up the scrim 100 may be any suitable yarn or fiber. “Yarn”, in this application, as used herein includes a monofilament elongated body, a multifilament elongated body, ribbon, strip, fiber, tape, and the like. The term yarn includes a plurality of any one or combination of the above. The yarns may be of any suitable form such as spun staple yarn, monofilament, or multifilament, single component, bi-component, or multi-component, and have any suitable cross-section shape such as circular, multi-lobal, square or rectangular (tape), and oval.

Some suitable materials for the yarns include aramid (including meta and para forms), polyester, polyolefin, nylon (including nylon 6, nylon 6,6, and nylon 4,6), steel, carbon, fiberglass, and polyethylene terephthalate (polyester or PET). In one preferred embodiment, the scrim 100 contains polyester yarns. In another preferred embodiment, the scrim 100 contains glass fibers.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A composite roofing membrane having an upper surface and a lower surface comprising, in order:
a first membrane having a first side and a second side, wherein the first side of the first membrane forms the upper surface of the composite roofing membrane, wherein the first membrane comprises a thermoplastic polymer;
a second membrane having a first side and a second side, wherein the first side of the second membrane is adjacent to and in direct and intimate contact with the second side of the first membrane, wherein the second membrane comprises a thermoplastic polymer, wherein there are no fibers or yarns between the first membrane and the second membrane; and,
a nonwoven fleece having a first side and a second side, wherein the first side of the nonwoven fleece and the second side of the second membrane are adjacent, wherein the nonwoven fleece contains a plurality of yarns, and wherein the nonwoven fleece has a tensile strength of between 100 and 1000 lb_{f} and a tear strength of between 20 and 200 lb_{f}.

2. The composite roofing membrane of claim 1, wherein the plurality of yarns is in a first scrim embedded into the nonwoven fleece.

3. The composite roofing membrane of claim 2, wherein the first scrim has a machine and cross-machine direction and comprises a plurality of glass fibers, wherein the first scrim has a construction selected from the group consisting of a knit, woven, or non-woven

4. The composite roofing membrane of claim 1, further comprising a first scrim embedded into the nonwoven fleece.

5. The composite roofing membrane of claim 4, wherein the first scrim has a machine and cross-machine direction and comprises a plurality of glass fibers, wherein the first scrim has a construction selected from the group consisting of a knit, woven, or non-woven

6. The composite roofing membrane of claim 1, wherein the yarns comprise a plurality of fibers having an average staple length at least 20 inches.

7. A roof comprising a roof deck and the composite roofing membrane of claim 1 adhered to the roof deck, wherein the composite roofing membrane is oriented such that the lower surface of the composite roofing membrane faces the roof deck.

8. A composite roofing membrane having an upper surface and a lower surface comprising, in order:
first membrane having a first side and a second side, wherein the first side of the first membrane forms the upper surface of the composite roofing membrane, wherein the first membrane comprises a thermoplastic polymer;
a nonwoven fleece having a first side and a second side, wherein the first side of the nonwoven fleece and the second side of the first membrane are adjacent, wherein the nonwoven fleece contains a plurality of yarns, wherein the nonwoven fleece has a tensile strength of between 100 and 1000 lb_{f} and a tear strength of between 20 and 200 lb_{f}.

9. The composite roofing membrane of claim 8, wherein the plurality of yarns is in a first scrim embedded into the nonwoven fleece.

10. The composite roofing membrane of claim 9, wherein the first scrim has a machine and cross-machine direction and comprises a plurality of glass fibers, wherein the first scrim has a construction selected from the group consisting of a knit, woven, or non-woven

11. The composite roofing membrane of claim 8, further comprising a first scrim embedded into the nonwoven fleece.

12. The composite roofing membrane of claim 11, wherein the first scrim has a machine and cross-machine direction and comprises a plurality of glass fibers, wherein the first scrim has a construction selected from the group consisting of a knit, woven, or non-woven

13. A roof comprising a roof deck and the composite roofing membrane of claim 8 adhered to the roof deck, wherein the composite roofing membrane is oriented such that the lower surface of the composite roofing membrane faces the roof deck.

14. A composite roofing membrane having an upper surface and a lower surface comprising, in order:
a first membrane having a first side and a second side, wherein the first side of the first membrane forms the upper surface of the composite roofing membrane, wherein the first membrane comprises a thermoplastic polymer;
a second membrane having a first side and a second side, wherein the first side of the second membrane is adjacent to and in direct and intimate contact with the second side of the first membrane, wherein the second membrane comprises a thermoplastic polymer, wherein there are no fibers or yarns between the first membrane and the second membrane; and,
a fire resistant (FR) fleece having a first side and a second side, wherein the first side of the FR fleece and the second side of the second membrane are in intimate contact, wherein the second side of the FR fleece forms the lower surface of the composite roofing membrane, wherein the FR fleece comprises a plurality of FR rayon staple fibers and a plurality of char scaffold fibers selected from the group consisting of partially oxidized acrylonitrile and silica staple fibers, wherein the FR fleece further comprises a first scrim embedded into the fleece, wherein the first scrim has a machine and cross-machine direction and comprises a plurality of glass fibers, wherein the first scrim has a construction selected from the group consisting of a knit, woven, or non-woven, and wherein the tensile strength of the first scrim in the machine direction is at least about 100 N/cm².

15. The composite roofing membrane of claim 14, wherein in the event of a fire, the first and second membrane at least partially melt or degrade and the fibers of the FR fleece at least partially embed into the second membrane.

16. The composite roofing membrane of claim 14, wherein the FR fleece comprises between about between about 30 and 70% by weight FR rayon staple fibers, between about 20 and 50% by weight scaffold fibers, and between about 20 and 50% by weight polyester fibers.

17. A roof comprising a roof deck and the composite roofing membrane of claim 14 adhered to the roof deck, wherein the composite roofing membrane is oriented such that the lower surface of the composite roofing membrane faces the roof deck.

18. A composite roofing membrane having an upper surface and a lower surface comprising, in order:
first membrane having a first side and a second side, wherein the first side of the first membrane forms the upper surface of the composite roofing membrane, wherein the first membrane comprises a thermoplastic polymer;
a fire resistant (FR) fleece having a first side and a second side, wherein the first side of the FR fleece and the second side of the first membrane are in intimate contact, wherein the second side of the FR fleece forms the lower surface of the composite roofing membrane, wherein the FR fleece comprises a plurality of FR rayon staple fibers and a plurality of char scaffold fibers selected from the group consisting of partially oxidized acrylonitrile and silica staple fibers, wherein the FR fleece further comprises a second scrim embedded into the fleece, wherein the second scrim has a machine and cross-machine direction and comprises a plurality of glass fibers, wherein the second scrim has a construction selected from the group consisting of a knit, woven, or non-woven, and wherein the tensile strength of the second scrim in the machine direction is at least about 100 N/cm².

19. The composite roofing membrane of claim 18, wherein in the event of a fire, the first and second membrane at least partially melt or degrade and the fibers of the FR fleece at least partially embed into the second membrane.

20. The composite roofing membrane of claim 18, wherein the FR fleece comprises between about between about 30 and 70% by weight FR rayon staple fibers, between about 20 and 50% by weight scaffold fibers, and between about 20 and 50% by weight polyester fibers.

21. A roof comprising a roof deck and the composite roofing membrane of claim 18 adhered to the roof deck, wherein the composite roofing membrane is oriented such that the lower surface of the composite roofing membrane faces the roof deck.
